(19) United States
(12) Patent Application Publication
(10) Pub. No.: US 2005/0090233 A1
(43) Pub. Date: Apr. 28, 2005

(54) System and method employing a mobile telephone to retrieve information regarding an article

(75) Inventors: Michael J. Chambers, Erlangen (DE); Michael Kiessling, Freising (DE)

Correspondence Address: HITT GAINES, PC;AGERE SYSTEMS INC., PO BOX 832570, RICHARDSON, TX, 75083, US

(73) Assignee: Agere Systems, Incorporated, Allentown, PA (US)

(21) Appl. No.: 10/695,603

(22) Filed: Oct. 28, 2003

(51) Int. Cl. H04M 3/16

(52) U.S. Cl. 455/412.1; 455/420; 455/566

(57) ABSTRACT

A system for, and method of, using a mobile telephone to retrieve information about an article and an associated mobile telephone. In one embodiment, the system includes: (1) a camera, associated with the mobile telephone, that records an image of at least a portion of the article and (2) a database, remote from the mobile telephone, that interprets the image to identify the article and supplies information about the article to the mobile telephone based thereon.

### CROSS-REFERENCE TO RELATED APPLICATION

The present application is related to U.S. patent application Ser. No. ______ [Attorney Docket No. [LUCT-124619]] to Chambers, et al., entitled “Mobile Telephone-based System and Method for Automated Data Input,” commonly assigned with the present invention, filed concurrently herewith and incorporated herein by reference.

### TECHNICAL FIELD OF THE INVENTION

The present invention is directed, in general, to wireless telecommunications and, more specifically, to a system and method employing a mobile telephone to retrieve information regarding an article.

### BACKGROUND OF THE INVENTION

Almost every article that can be bought in a store or a warehouse is nowadays provided with coded data attached to it. The most commonly used code in this respect is a barcode, which usually takes the form of a one-dimensional barcode, though two-dimensional barcodes are also used increasingly.

The checkout stand of a store usually is provided with a barcode reader connected to a computer having access to a database holding information on each article sold in the store and especially holding price information associated with each article. The same database often also holds inventory information on how many pieces of each article are currently in stock.

Especially in stores with a large assortment of articles, a customer often gets in a situation in which he wants to know the price of an article that has no readable price on or next to it and therefore needs to read the coded data, especially the pricing information. For this purpose some stores provide “public” barcode or similar readers. This, however, involves additional costs to the store.

Another situation in which it would be useful for the customer to be able to read the coded data is in a store that accepts all kinds of different currencies, for instance located at an international airport, in order to get the pricing information for an article in his own currency.

Furthermore, it is necessary for store employees, including those remote from the checkout stand, to be able to read the coded data and relate this data to the price of an article.

A possibility for reading barcode-based data is to use a barcode reader equipment that can be connected to a mobile phone, enabling the user to send the data to a certain server based service with a database for receiving back the pricing information at the mobile phone. However, one problem with this arrangement is that, in addition to a mobile phone, additional equipment (e.g., a barcode reader) is needed, which reduces the ease of use and increases the costs. Additionally the performance is restricted due to the limited bit-rates GSM communication networks still offer.

Accordingly, what is needed in the art is a way to retrieve information regarding an article based on coded data gathered from the article, particularly in an easy, low cost and fast manner.

### SUMMARY OF THE INVENTION

To address the above-discussed deficiencies of the prior art, the present invention provides, in one aspect, a system for using a mobile telephone to retrieve information about an article and an associated mobile telephone. The system includes: (1) a camera, associated with the mobile telephone, that records an image of at least a portion of the article and (2) a database, remote from the mobile telephone, that interprets the image to identify the article and supplies information about the article to the mobile telephone based thereon.

In another aspect, the present invention provides a method of using a mobile telephone to retrieve information about an article. The method includes: (1) recording an image of at least a portion of the article with a camera associated with the mobile telephone, (2) interpreting the image to identify the article and (3) supplying information about the article to the mobile telephone based thereon.

In yet another aspect, the present invention provides a mobile telephone. The mobile telephone includes: (1) a camera, (2) software that receives an image of at least a portion of an article from the camera, interprets the image to identify the article and queuing data based thereon for transmission to a database remote from the mobile telephone and (3) a display that receives and displays information about the article from the database.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic diagram of one embodiment of a system for using a mobile telephone to retrieve information about an article constructed according to the principles of the present invention; and

FIG. 2 illustrates a flow diagram of one embodiment of a method of using a mobile telephone to retrieve information about an article carried out according to the principles of the present invention.

### DETAILED DESCRIPTION

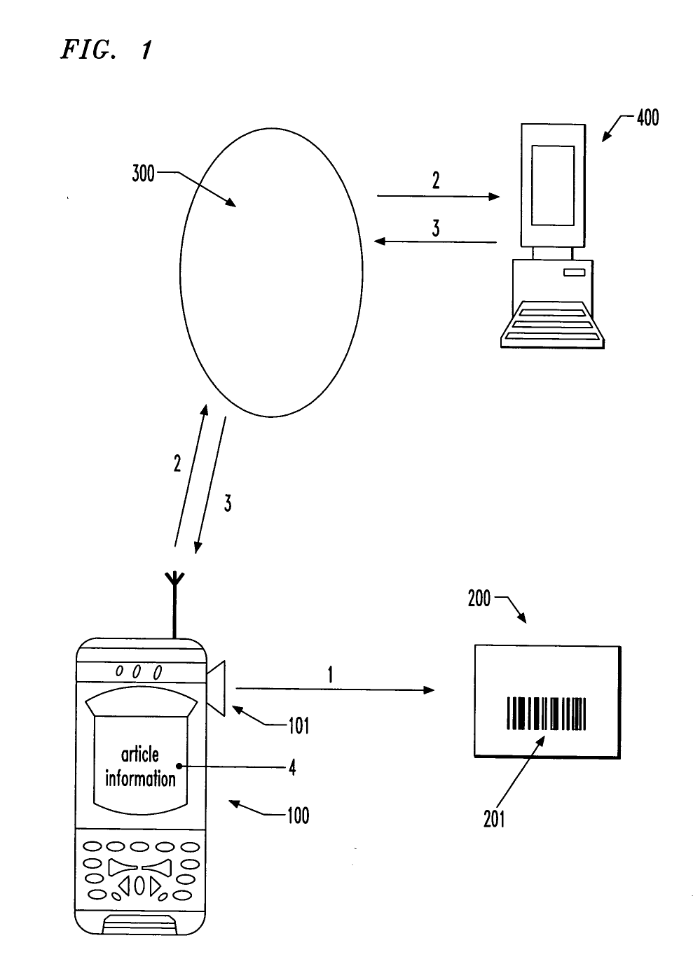

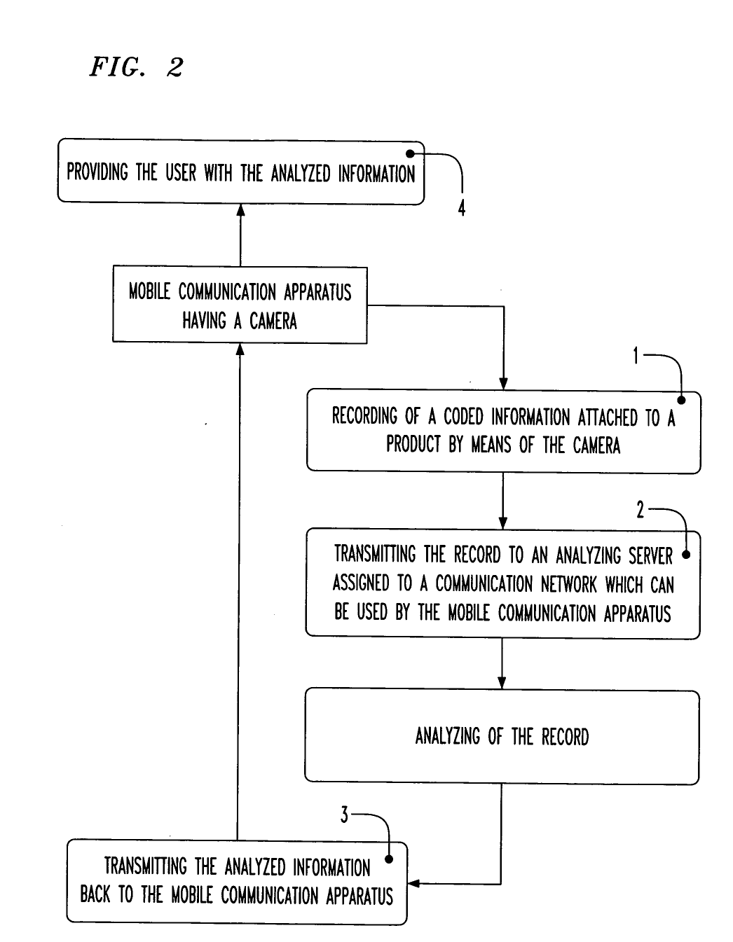

FIG. 1 illustrates a schematic diagram of one embodiment of a system for using a mobile telephone to retrieve information about an article constructed according to the principles of the present invention. FIG. 2 illustrates a flow diagram of one embodiment of a method of using a mobile telephone to retrieve information about an article carried out according to the principles of the present invention. An exemplary embodiment of the invention will now be described with reference to FIG. 1 and FIG. 2.

According to FIG. 1, a mobile phone 100 is depicted having a photo camera 101 mounted to the mobile phone 100. An article 200 is marked having in the example a barcode 201 attached thereto, that includes coded information about the article 200, such as price information.

If the user of the mobile phone 100 wants to read and understand the coded information 201 of the article 200, a picture 1 of the barcode 201 is recorded by use of the camera 101 of the mobile phone 100. The record of the barcode 201 then is transmitted via an air link 2 through at least one communication network 300 to a server 400, for example a Web-based server providing an analyzing service for analyzing the transmitted image and hence the barcode to ascertain the information thereof.

The server 400 has accessibility to or is preferably directly connected to a database (not shown) wherein a plurality of different code and/or article information is stored. In a practical manner, the received visual record is processed by an image recognition system of the server 400 for ascertaining the barcode 201 which then is compared with the database information for decoding the barcode and hence for analyzing the information thereof or preferably directly decoded by a server based barcode reader. Moreover, if additional information related to a certain barcode or article is stored within a database the additional information may be taken account and/or drawn up, too. In this regard, the database may be additionally synchronized with databases of certain distributors of the article 200, for example, to access detailed and/or specific information.

Once the image of the barcode 201 and based thereon the coded information is analyzed, at least the analyzed information, such as an analyzed price information of the article 200 is then transmitted back, as indicated by reference numeral 3 to the mobile phone 100. At the mobile phone 100, the received analyzed and possibly additional information is depicted according to FIG. 1 at the display, as referenced by reference numeral 4, so that the user of the mobile phone 100 can read the information embedded within the barcode 201.

The transmission of the visual record from the mobile communication apparatus 100 to the server 400 providing the server based code reading functionality as well as the transmission of the analyzed information back to the mobile communication apparatus 100 is preferably performed by use of a Multimedia Message Service (MMS) or by use of an e-mail. In this regard, it will be apparent to a person skilled in the pertinent art that both the mobile phone 100 and the server 400 should be adapted accordingly by the respective interfaces operating for example on a General Packet Radio Service (GPRS) or a Universal Mobile Telecommunications System (UMTS) standard. However, in particular with regard to the transmission of the analyzed information, a Short Message Service (SMS) or speech data transmission may be used, if the server is adapted accordingly. In the last case the server preferably comprises a speech processing system adapted to convert the ascertained information into speech data which can be acoustically indicated for the user via a loud speaker integrated within the mobile phone 100.

Since a provider possibly wants to charged his server based service of analyzing a coded information the server 400 is preferably transmitting accompanying charge information to a charging system for charging the service use. Such charge information can be directly sent back to the mobile phone 100 together with the analyzed article information, especially in case a prepaid card is implemented within the mobile phone 100 or may be transmitted to an external charging system for periodically debit an account assigned to the mobile phone or to its registered user.

Although the invention is described with regard to a specific embodiment, the invention is covering at least several modified embodiments, without leaving the scope of protection as defined by the appended set of claims.

For example, the internal or externally connectable camera of the mobile communication apparatus may be additionally or alternatively designed as being a video camera, so that the record is at least a part of a video sequence. Instead of the described mobile phone, an other mobile communication apparatus may be used by the invention, for example a Personal Digital Assistant (PDA) or a Mobile Digital Assistant (MDA).

The record may be pre-processed prior to its transmission to the analyzing server, for example by the transformation into a format adapted for transmission and/or for the analyzing server. In particular a special application may be provided within the mobile communication apparatus for handling the data transfer, e.g., by using a TCP/IP data link and/or the server may provide a special data link format to interact with the mobile communication apparatus. Moreover, a plurality of records relating to different articles may be stored within a memory of the communication apparatus prior to transmit the records all together to the analyzing server.

Although the present invention has been described in detail, those skilled in the art should understand that they can make various changes, substitutions and alterations herein without departing from the spirit and scope of the invention in its broadest form.

1. A system for using a mobile telephone to retrieve information about an article, comprising:
a camera, associated with said mobile telephone, that records an image of at least a portion of said article; and
a database, remote from said mobile telephone, that interprets said image to identify said article and supplies information about said article to said mobile telephone based thereon.

2. The system as recited in claim 1 wherein said image is received from said mobile telephone via a selected one of:
an infrared connection, and
a direct radio link.

3. The system as recited in claim 2 wherein said direct radio link conforms to a standard selected from the group consisting of:
Bluetooth,
WLAN, and
HomeRF/SWAP.

4. The system as recited in claim 1 wherein said image contains coded data and said coded data is decoded in a server associated with said database.

5. The system as recited in claim 1 wherein said mobile telephone contains software that defines a structure corresponding to said database.

6. The system as recited in claim 1 wherein said image contains coded data and said coded data is contained in a barcode.

7. The system as recited in claim 1 wherein said mobile telephone provides said information to a user a selected one of:
visually, and
acoustically.

8. The system as recited in claim 1 wherein said information comprises price information and said information is transmitted back to said mobile telephone via a selected one of:
Multimedia Message Service (MMS), and
email.

9. The system as recited in claim 8 wherein said database contains said price information in at least two different currencies.

10. The system as recited in claim 1 wherein a memory in said mobile telephone stores data pertaining to a plurality of articles and said image is a video sequence.

11. A method of using a mobile telephone to retrieve information about an article, comprising:
recording an image of at least a portion of said article with a camera associated with said mobile telephone;
interpreting said image to identify said article; and
supplying information about said article to said mobile telephone based thereon.

12. The method as recited in claim 11 wherein said image is received from said mobile telephone via a selected one of:
an infrared connection, and
a direct radio link.

13. The method as recited in claim 12 wherein said direct radio link conforms to a standard selected from the group consisting of:
Bluetooth,
WLAN, and
HomeRF/SWAP.

14. The method as recited in claim 11 wherein said image contains coded data, said method further comprising decoding said coded data in a server associated with said database.

15. The method as recited in claim 11 wherein said mobile telephone contains software that defines a structure corresponding to said database.

16. The method as recited in claim 11 wherein said image contains coded data and said coded data is contained in a barcode.

17. The method as recited in claim 11 further comprising providing, with said mobile telephone, said information to a user a selected one of:
visually, and
acoustically.

18. The method as recited in claim 11 wherein said information comprises price information and said information is transmitted back to said mobile telephone via a selected one of:
Multimedia Message Service (MMS), and
email.

19. The method as recited in claim 18 wherein said database contains said price information in at least two different currencies.

20. The method as recited in claim 11 further comprising storing, in a memory in said mobile telephone, data pertaining to a plurality of articles and said image is a video sequence.

21. A mobile telephone, comprising:
a camera;
software that receives an image of at least a portion of an article from said camera, interprets said image to identify said article and queues data based thereon for transmission to a database remote from said mobile telephone; and
a display that receives and displays information about said article from said database.
